(19) United States
(12) Patent Application Publication
(10) Pub. No.: US 2008/0295864 A1
(43) Pub. Date: Dec. 4, 2008

(54) Scavenging cleaning system

(76) Inventor: John C. Turner, Putney (AU)

Correspondence Address: BRIAN C. TRASK, 3601 EAST HERMES DRIVE, SALT LAKE CITY, UT, 84124, US

(21) Appl. No.: 12/156,020

(22) Filed: May 29, 2008

Related U.S. Application Data
(63) Continuation-in-part of application No. PCT/IB2006/054374, filed on Feb. 21, 2006.

(30) Foreign Application Priority Data
Nov. 30, 2005 (AU) 2005606693
Oct. 19, 2006 (AU) 2006905799
Oct. 24, 2006 (NZ) 550711

(51) Int. Cl. B08B 3/02

(52) U.S. Cl. 134/6

(57) ABSTRACT

A scavenging cleaner utilizing in combination within a cleaner body, a high-pressure liquid cleaner and recycling system, designed for substantially domestic use and in particular for where water use restrictions apply and for the cleaning of hard surfaces of any orientation. The cleaner comprises a reservoir of liquid, a supply and recovery sub-system with a variable capacity vacuum pump arrangement coacting with a pressure pump such that as the pressure pump capacity is decreased or stopped the capacity of the vacuum pump arrangement automatically increases to maximize liquid scavenging. Total electric current draw is maintained substantially constant and below a preset maximum. A flexible connecting hose system connects the body to a handheld delivery/brush/recovery head that is worked over the surface to be cleaned. Liquid is delivered at high-pressure to the surface with substantially all the liquid being recovered, filtered and repeatedly reused.

This application is a continuation-in-part of PCT International Patent Application No. PCT/IB2006/054374, filed on Feb. 21, 2006, designating the United States of America, and republished, in English, as PCT International Publication No. WO 2007/063452, on Feb. 7, 2008, and claims priority to Australia Application Nos. 200590663 and 2006905799 and New Zealand Application No; 550711, the contents of the entirety of all of which are hereby incorporated by this reference.

The present invention relates to liquid jet cleaning devices and, more particularly, to devices employing a liquid recovery and reuse system.

### BACKGROUND

Water has increasingly come to be recognised as a limited supply resource so that costs and regulatory restrictions on its availability and application increasingly create a demand for its more efficient use.

Some commonly used applications of water for cleaning purposes have become either severely restricted or prohibited entirely. An example is the washing of motor vehicles or other hard surfaced structures using free flowing hoses connected to the reticulated water supply. This activity consumes and largely wastes significant volumes of water, and hence is one of the first water uses to be restricted or banned.

Although use of high-pressure water cleaning jets use significantly less water for a given result than do free flowing mains supplied hoses, the water used by these devices is wasted.

Cleaning machines utilising liquid recovery but without liquid reuse are described in numerous patent specifications—one as early as 1930 in U.S. Pat. No. 1,982,345. A more sophisticated device utilising liquid recycle but with separate and sequential cleaning and recovery cycles is disclosed in U.S. Pat. No. 3,431,582 in 1969. A refinement by the same inventor disclosed in U.S. Pat. No. 4,466,155 in 1982 allows for continuous simultaneous cleaning and recovery cycles. The machines described in these specifications appear to be more specifically designed for commercial use mostly for cleaning of floors and not particularly suitable for cleaning of surfaces of any orientation in a domestic situation. Indeed smaller compact recycling cleaners utilising high pressure and specifically designed for domestic use are not available commercially and there is a need for them. Large industrial floor cleaners that recover and reuse the cleaning liquid are available but again they are not for domestic use and are limited to cleaning floors or other substantial, horizontal or near horizontal flat surfaces.

Pressure cleaners as described in the foregoing cited prior art and examples are not suited to domestic use principally because the cumulative power requirements of an effective vacuum scavenging system and a pressure pump capable of delivering sufficient cleaning fluid at a sufficiently high pressure are beyond the electrical capacity of the domestic power outlet. By domestic power outlet we mean any electric power outlet suitable for portable appliances that may be found within domestic premises. For example in Australia the most common domestic power outlet is a single phase, 240 volt outlet with a maximum electric current draw of 10 amps current which in general means that the maximum power consumption of any connected appliance is limited to a nominal 2400 watts. Single phase, 15 amp power outlets with a nominal 3600 watt capacity are also used but are not as common. Similarly the USA domestic power outlet capacities are 15 and 20 amps at 115 volts resulting in nominal capacities of 1725 watts and 2300 watts respectively.

It is an object of the present invention to address or ameliorate some of the above disadvantages and limitations or to at least provide the public with a useful choice.

Note: The term “comprising” (and grammatical variations thereof) is used in this specification in the inclusive sense of “having” or “including”, and not in the exclusive sense of “consisting only of”.

DEFINITION: Within this specification the term “complimentary” when qualifying the mode of operation of electric motors means “in an opposite manner to”. For example switching the motors in a complimentary manner means switching one on as another is switched off and modulating the motors in a complimentary manner means increasing the speed of one whilst simultaneously decreasing the speed of another.

### BRIEF DESCRIPTION OF INVENTION

In a first broad form of the invention there is provided a high pressure scavenging cleaning system substantially for domestic use, said cleaner comprising in combination:

(a) a reservoir of liquid and a supply and recovery sub-system located in association with a cleaner body;

(b) a pressure pump as part of the said supply and recovery sub-system;

(c) a variable capacity vacuum pump arrangement as part of the said supply and recovery sub-system coacting with the said pressure pump located within said cleaner body;

(d) a switch and control mechanism controlling the operation of the said pressure pump and the said vacuum pump arrangement in an automatic and coordinated manner;

(e) a flexible connecting hose system comprising a plurality of fluid conducting passages; said hose system extending from said body and connected at a first end to said cleaner and at a second end to a delivery/recovery head; said passages in fluid communication with said reservoir of liquid and said supply and recovery sub-system; at least one of said passages further in vacuum communication with said vacuum pump arrangement,

and wherein the said variable capacity vacuum pump arrangement is modulated in a continuous or stepwise manner or simply switched between a non-zero minimum and a maximum capacity in a complimentary, reverse manner to the said pressure pump as it is modulated in a continuous or stepwise manner or simply switched between a maximum and zero capacity by the said switch and control mechanism such that the combined electric current draw for both said pressure pump and said vacuum pump arrangement is maintained substantially constant and at any one time below but close to a preset maximum and wherein the sum of the individual maximum electric current draws for the said vacuum pump arrangement and the said pressure pump each in isolation is significantly greater than said preset maximum; the arrangement being such that at any one time the said cleaner generates an optimum vacuum capacity, by substantially utilising the allowable electric current; said allowable electric current being the difference between the said preset maximum and the electric current draw of the pressure pump at the said any one time and wherein said delivery/recovery head is separated from the said body of the said cleaner by the said communicating hose system and wherein said delivery/recovery head can be light and easily moved over surfaces to be cleaned, of any orientation from horizontal to vertical (such as a motor vehicle body) and wherein said delivery/recovery head includes a delivery nozzle and at least one liquid recovery inlet orifice, whereby liquid from said reservoir of liquid and said supply and recovery sub-system is delivered at high-pressure to a target surface of application, and wherein substantially all said liquid so delivered is recovered and repeatedly reused by the cleaner.

Preferably said preset maximum electric current draw is substantially equal to the maximum allowable electric current draw from a domestic power outlet.

Preferably said switch and control is adapted to selectively enable all individual motorized components of the said supply and recovery sub-system to be manually switched to a non-operational state.

Preferably said vacuum pump arrangement comprises a plurality of vacuum pumps fitted to a common vacuum receiving chamber; each of said plurality of vacuum pumps individually controllable such that said vacuum pump arrangement as a whole exhibits a modulating effect and is capable of delivering a variable air flow and vacuum with a corresponding variable electrical current draw.

Preferably said plurality of vacuum pumps comprises two vacuum pumps.

Preferably one vacuum pump of said two vacuum pumps has a maximum electric current draw substantially equal to the maximum electric current draw of said one pressure pump and wherein said one vacuum pump is arranged to switch from off to on automatically as said pressure pump switches from on to off such that the operational states of said one vacuum pump and said pressure pump are mutually exclusive thereby ensuring that the total electric current draw for the cleaner remains substantially constant and can never include both the electric current draw of the said vacuum pump and the said pressure pump at the same time.

Preferably each of said vacuum pumps is provided with a one-way valve adapted to prevent an operational vacuum pump drawing air through an adjacent non-operational vacuum pump, thereby to ensure substantially all air entering said common vacuum receiving chamber is drawn from the supply and recovery sub-system so as to maximise scavenging of liquid at the delivery/recovery head.

Preferably the modulation of said vacuum pump arrangement is effected by means of an at least one vacuum pump provided with an electronic variable speed drive system.

Preferably the modulation of said pressure pump is effected by means of providing said pressure pump with an electronic variable speed drive system.

Preferably the modulation of said vacuum pump arrangement and said pressure pump is effected by means of providing at least one vacuum pump and the said pressure pump with an electronic variable speed drive system on each.

Preferably said electronic variable speed drive systems are in turn controlled by an electronic control in a complimentary manner such that as the pressure pump speeds up the at least one vacuum pump slows down such that the combined electric current draw for both said pressure pump and said vacuum pump arrangement is maintained substantially constant and below the preset maximum.

Preferably at least one swivel connection is located in said hose system.

Preferably said liquid from said reservoir of liquid and a supply and recovery sub-system is delivered by the said pressure pump at a pressure up to 3000 psi.

Preferably said cleaner further incorporates a liquid separation device whereby liquid returning to said cleaner is substantially separated from an air stream within which it is entrained in order to reduce the amount of entrained liquid droplets presenting to said vacuum pump arrangement and wherein said liquid separation device provides a physical separation between said air stream and said reservoir of liquid within said cleaner.

Preferably said liquid separation device includes a cyclonic separator.

Preferably said liquid separation device includes a vane type separator; said vane type separator adapted to separate a liquid from an air stream by means of trapping entrained liquid behind vanes at points where said gas stream is forced to change direction by said vanes.

Preferably said physical separation is provided by means of a shallow upper cone placed one on top of a shallow inverted lower cone such that said upper cone is pointed upwards and provides a first liquid draining surface extending to a periphery of said liquid separation device and said lower cone and wherein said lower cone forms a tundish; said lower cone truncated to form a central orifice such that liquid having drained from said periphery is captured by said lower cone; said lower cone providing a second draining surface extending to said central orifice.

Preferably said cleaner body is supported on wheels or skids whereby said cleaner can be urged and moved from a first location to a second location without being lifted clear of the surface upon which it rests.

Preferably said cleaner further incorporates at least one filter within said body; said at least one filter filtering liquid returned from said delivery nozzle and liquid recovery inlet orifice via said hose system prior to said liquid presenting to the said pressure pump for reuse.

Preferably said at least one filter comprises a cartridge filter.

Preferably said at least one filter is fabricated from or contains material adapted to have an affinity with selected contaminants returning to said cleaner body in said air stream and recovered liquid.

Preferably said at least one filter within said cleaner body is enclosed within an enclosed filter housing such that the entire surface area of said at least one filter is utilised even at very low liquid levels within said cleaner reservoir.

Preferably said filter housing is comprised of an inverted, open container sealed but for a small gap at the bottom to allow said liquid to pass through from said reservoir to said at least one filter.

Preferably a 3-way-valve is located in a liquid conduit between said reservoir of liquid and said pressure pump. Said 3-way-valve connecting at a first port to said reservoir, at a second port to said pressure pump and having a third port available for connection to a supply hose such that any two or all three of said ports may be interconnected.

Preferably said delivery/recovery head comprises a hand-held housing and a head portion rigidly and strongly connected by a connecting piece such that said head portion can be easily moved over the surface to be cleaned; said head portion incorporating a base portion and a brush assembly and said delivery nozzle and said at least one liquid recovery inlet orifice and wherein said connecting piece is of a length and orientation such that said hand piece is at a practical working distance from the face of the delivery/recovery head for the cleaning of solid surfaces.

Preferably said delivery nozzle is controlled by a trigger assembly on said hand-held housing and wherein said trigger assembly operates:

a direct acting valve to open and close flow to said delivery nozzle or

a first switch and control that in turn operates the said pressure pump.

Preferably said pressure pump is provided with an over-pressure sensing switch adapted to detect when pressure supplied by said pump exceeds a predefined threshold and wherein said overpressure switch acts to turn off said pump when flow from said pump is obstructed when said trigger is released to operate said direct acting valve to close flow to said delivery nozzle while said delivery/recovery head is in use.

Preferably said delivery nozzle is adjustable such that the spray pattern of liquid issuing from the said nozzle can be made smaller and more concentrated or wider and less concentrated.

Preferably said delivery nozzle is recessed within said brush assembly; the bristles of said brush or like structure extending beyond said delivery nozzle so as to contact said vehicle body or other surface at a predetermined distance in advance of said delivery nozzle.

Preferably said bristles of the said brush assembly are arranged in an at least one array; said delivery nozzle located centrally within said at least one array; said at least one array forming an at least one enclosure when in contact with said surface; said at least one enclosure adapted to substantially capture liquid emitted by said delivery nozzle for return to said body via said at least one liquid recovery inlet orifice in communication with the said vacuum pump arrangement through the said hose system.

Preferably said at least one liquid recovery inlet orifice is arranged at the periphery of said array.

Preferably said head portion of the said delivery/recovery head is provided with an at least one flexible skirt of elastomeric non-marking material such as silicone rubber attached to the said base portion or the said brush assembly and complimenting or replacing a portion of the said bristles of the said at least one array; said flexible skirts positioned at any one of or combination of the following positions:

the extreme outer periphery of the said at least one array;

the peripheral edges of the said at least one enclosure within the said at least one array;

the arrangement being such that the said at least one flexible skirt substantially maintains a seal with the surface of application and acts to firstly prevent liquid escaping from the said extreme outer periphery of the said at least one array and secondly to channel and guide the said liquid and the air being drawn into the said at least one liquid recovery inlet orifice by the said vacuum pump arrangement via the said hose system.

Preferably the said head portion comprises the said base portion to which is attached 2 substantially concentric generally annular arrays of bristles; said generally annular arrays forming 2 internal enclosures when in contact with a surface, being a first central enclosure into which liquid is injected through said delivery nozzle fixed to the said base portion and a second outer generally annular enclosure between the said substantially concentric generally annular arrays; said second generally annular enclosure being in fluid communication with at least one said liquid recovery inlet orifice in the base portion and wherein said flexible skirts are positioned at the outer peripheral edges of both the inner and the outer said generally annular arrays; the arrangement being such that cleaning liquid injected into the cleaning head through the said delivery nozzle hits the surface of application and migrates outwardly through and past the bristles of the said inner generally annular array and under the inner said flexible skirt and into the said generally annular enclosure where said liquid is substantially drawn into at least one said liquid recovery inlet orifice communicating with said generally annular enclosure adapted to facilitate capture of said liquid.

Preferably said outer flexible skirt and said generally annular array of bristles is angled out away from said inner skirt such that when pressure is applied to said delivery/recovery head against said surface of application being cleaned, said outer skirt slidingly folds outwards so as to substantially maintain integrity of said enclosure and said seal with said surface and to increase the effective cleaning area of the said delivery/recovery head above the projected area of the said base portion of the said delivery/recovery head.

Preferably said at least one flexible skirt is releasably attached to said base portion or said brush portion so as to be readily replaceable when worn or damaged.

Preferably said vacuum pump arrangement discharges into an exhaust manifold; said exhaust manifold providing a source of pressurised air and having an exhaust port adapted to accept connection of a blower hose to said vacuum pump arrangement to facilitate blowing down or drying of surfaces.

In a further broad form of the invention there is provided a method for the minimisation of liquid usage in a domestic water-jet cleaning operation within the limitation of a preset maximum electric current draw; said method including the steps of:

supplying said liquid from a portable reservoir of liquid and a supply and recovery sub-system containing a variable capacity vacuum pump arrangement coacting with a pressure pump via a first hose passage and a delivery nozzle of a delivery/recovery head,

providing said delivery/recovery head with a projecting generally annular brush in combination with flexible elastomeric skirts forming an enclosure when ends of bristles of said brush and said skirts are in contact with a surface,

supplying vacuum pressure via a second hose passage to said enclosure so as to substantially return liquid issuing from said delivery nozzle to said reservoir of liquid and a supply and recovery sub-system via said second hose passage, and

controlling the said variable capacity vacuum pump arrangement such that the electric current draw for the cleaner is maintained substantially constant and below a preset maximum at all times regardless of the operational state and output of the said pressure pump.

Preferably said cleaning operation is on a hard surface of any orientation amenable to cleaning with a high pressure liquid jet.

### BRIEF DESCRIPTION OF DRAWINGS

Embodiments of the present invention will now be described with reference to the accompanying drawings wherein:

FIG. 1 is a schematic representation of a scavenging cleaning system according to a preferred embodiment of the invention,

FIG. 2 is a detailed view of a delivery nozzle and brush arrangement of a liquid delivery and recovery head of the preferred embodiment of FIG. 1,

FIG. 3A is a sectioned view of the liquid delivery and recovery head of FIG. 2,

FIG. 3B is a sectioned view of a preferred form of a liquid delivery and recovery head utilising flexible rubber type skirts.

FIG. 3C is a sectioned view of a further preferred form of a liquid delivery and recovery head utilising flexible rubber type skirts and pressurised air.

FIG. 3D is a view of a preferred form of hand piece most suitable for the cleaning of walls and floors or similar where some scrubbing action is desirable.

FIG. 4 is a further view of the liquid delivery and recovery head of FIGS. 2 and 3A and 3B when fitted with a trailing wheel device.

FIG. 5 is a schematic representation of a preferred form of vacuum pump arrangement consisting of two vacuum pumps.

FIG. 6 is a view of a preferred filter and pressure pump arrangement.

FIG. 6A is an enlarged view of the filter of FIG. 6.

FIG. 7A is a plan view of a preferred form of liquid separation device including cyclonic action and a vane type separator.

FIG. 7B is a sectional view of the liquid separation device depicted in FIG. 7A.

FIG. 8A is a simple circuit diagram showing relay control of the pressure pump motor and vacuum motor 1.

FIG. 8B is a simple circuit diagram showing variable speed control of the pressure pump motor and vacuum motor 1.

FIG. 9A is a time series graph illustrating the power absorbed by each motor in a cleaner that incorporates relay control of the pressure pump motor and vacuum motor 1.

FIG. 9B is a time series graph illustrating the power absorbed by each motor in a cleaner that incorporates variable speed control of the pressure pump motor and vacuum motor 1.

### DETAILED DESCRIPTION OF PREFERRED EMBODIMENTS

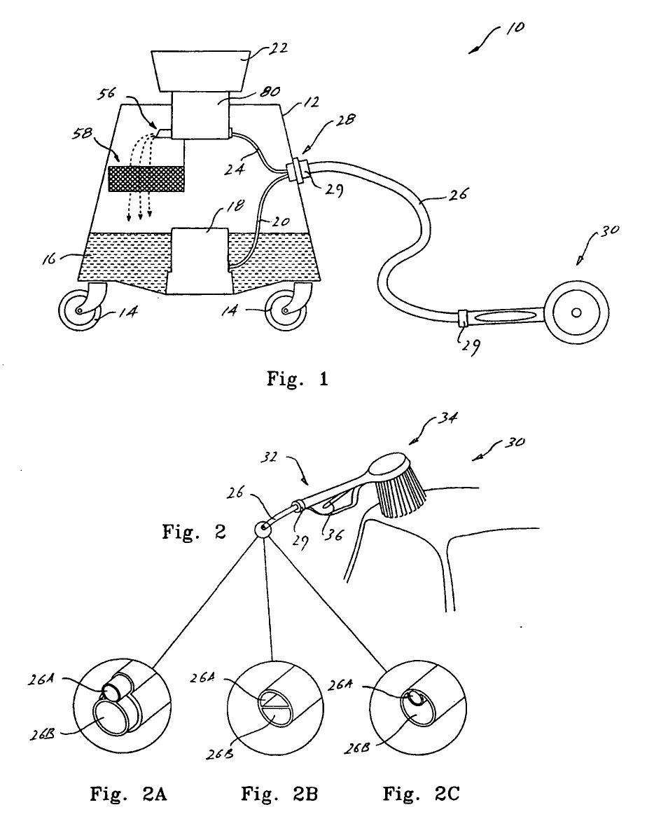

With reference to FIG. 1, a scavenging cleaning system 10 includes a portable cleaner vehicle body 12 forming a housing for a reservoir of liquid and a supply and recovery sub-system wholly contained within body 12.

Preferably body 12 is mounted on wheels 14, skids or the like, so as to allow movement over a supporting surface without the need for lifting the cleaning system 10.

Body 12 is adapted to accept and retain a volume of cleaning liquid 16, typically water, to which may be added a cleaning agent and or a de-foaming agent. Preferably such cleaning agent has non-foaming properties and is non corrosive to the cleaner component parts.

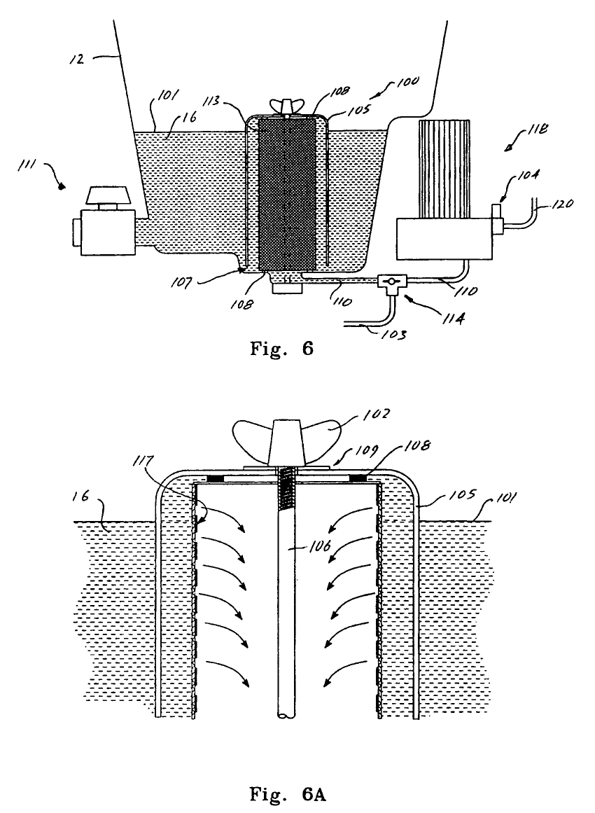

Located in the base of body 12, so as to maintain a low centre of gravity, is a pressure pump 18 adapted to draw from liquid 16 and deliver the liquid at high pressure to first hose 20. Preferably the output pressure of pump 18 is in the range of 2 to 3000 psi. Preferably, in a high pressure form of the cleaner the output pressure of pump 18 is in the range of 1000 to 1500 psi but higher pressures up to a maximum of 3000 psi might be more suitable for some applications. Preferably, in a low pressure form of the cleaner where high pressures may damage the surface to be cleaned the output pressure of pump 18 is in the range of 2 to 100 psi. Pressure pump 18 can be a submersible pump within the chamber as shown in FIG. 1, or, if not submersible, located external to the chamber holding the liquid 16 as can be seen with pump 118 in FIG. 6.

Now with reference to FIG. 6 and enlargement FIG. 6A, the pressure pump 118 external to body 12, draws liquid 16 from the body 12 through filter assembly 100 and piping 110. Filter assembly 100 contains a cylindrical filter 113, preferably a cartridge filter of a porous textile supported on a frame 117. Filter 113 is located within an enclosed filter housing 105 with both filter 113 and housing 105 held rigidly in place by means of threaded rod 106 and blind wing nut 102. The filter housing 105 extends almost to the bottom of body 12 leaving a gap 107 for the liquid 116 to pass through. The filter 113, housing 105 and body 12 seal one to each other by means of rubber rings 108 or the like; one seal located at the top and the other located at the bottom of filter 113. Wing nut 102 seals against the housing 105 by means of sealing washer 109.

The arrangement thus described allows the pump 118 to draw liquid through the filter 113 over its entire filter surface even when the liquid 16 surface 101 drops below the level of the top of the filter 113. Indeed the filter 113 will continue to filter over its entire filter surface until the liquid level drops to the point where air can enter the housing 105 through the gap 107.

A 3-way-valve 114 is provided in piping 110, between the filter 113 and the pump 118 allowing any two or all three of the three ports of valve 114 to be interconnected. The valve 114 allows for firstly, the body 12 to be filled with liquid from a supply hose 103; secondly, for the pump 118 to be primed under pressure from the supply hose 103 or thirdly, for the pump 118 to draw liquid 116 directly from the body 12.

Preferably body 12 is fitted with a large bore drain valve 111 to facilitate the draining and cleaning of the body.

Pressure pump 118 is fitted with a pressure switch 104 at the outlet of the pump. Pressure switch 104 can be used to control a mutually exclusive switching between operational and non-operational states of the pressure pump 118 and component vacuum pumps 70 of a vacuum pump arrangement 22 (shown in FIG. 5) as will be explained below. Pressure switch 104 is adapted to act as an over-pressure sensing switch to detect when pressure supplied by said pump exceeds a predefined threshold. Switch 104 also acts to turn off the pump when flow from the pump is obstructed when the delivery/recovery head trigger is released to close the delivery nozzle.

With reference to FIG. 5, there is shown a schematic diagram of the vacuum pump arrangement 22, located at the top of body 12 (as shown in FIG. 1). In a preferred arrangement, two vacuum pumps 70, each with a one-way valve 71 at the pump inlet, are fitted into a common vacuum receiving chamber 72. Air is drawn into the vacuum receiving chamber 72, entering through vacuum receiving chamber inlet 73 and thence through one-way valves 71 and vacuum pumps 70.

Vacuum pumps 70 can discharge through their exhaust ports 74 into a common exhaust manifold 75. An exhaust fitting 76 in the manifold 75 allows a blower hose 77 to be connected to the vacuum pump arrangement 22 for the purpose of blowing any residual liquid from cleaned surfaces and other similar purposes.

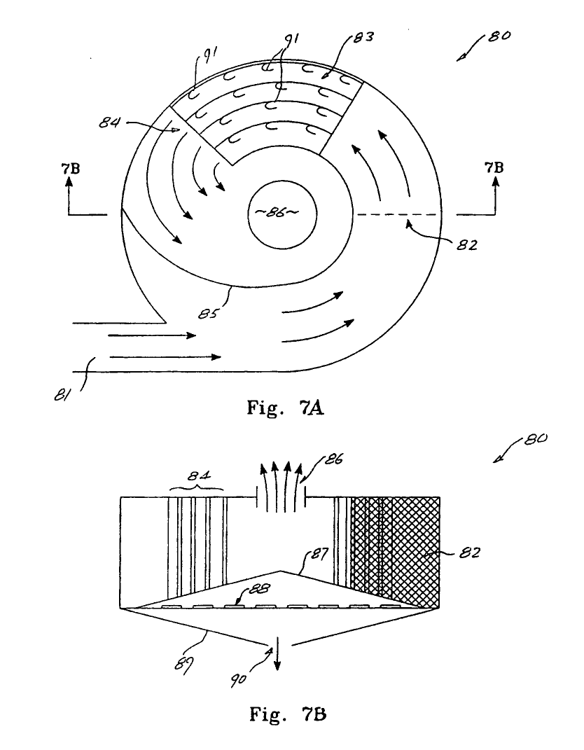

Now with reference to FIGS. 7A and 7B there is shown a plan and sectioned side view of a preferred form of a liquid separation device 80. A returning airstream with entrained liquid enters the separation device 80 through tangential inlet pipe 81. Heavier entrained particulates and a portion of the entrained liquid are thrown to the outer surface of the separation device 80 by centrifugal force. Larger size particulates are prevented from further travel by course screen 82 where they collect. The airstream with the remaining liquid continues around to vane separator 83. Vanes 91 force directional changes in the airstream to trap liquid particles so that substantially all of the remaining liquid is removed from the airstream which continues out through the exit 84 of vane separator 83 and exits the separation device 80 through central exit pipe 86. Exit pipe 86 communicates with the inlet 73 of the vacuum pump arrangement 22 previously described and shown in FIG. 5. Bypass of liquid from the inlet 81 to the exit 86 is prevented by means of an internal dividing wall 85. The base of the separation device 80 is formed by conical section 87 (as shown in FIG. 7B) with a series of slots 88 in its peripheral edge which sits on, and slightly inside an inverted and truncated conical section, or tundish 89. Liquid separated from the airstream drains to the outside of conical section 87, through slots 88 and into tundish 89. Freed from the turbulence of the airstream the liquid drains to opening 90 and into the reservoir of liquid within body 12. The components of separation device 80 are assembled by means of various fasteners (not shown) adapted to allow rapid disassembly for ease of cleaning when required.

It has been found that the inclusion of vane separator 83 in this design of separation device 80, guarantees almost complete separation of the entrained liquid, although an adequate separation for some applications can be achieved by the combination cyclonic action and the use of opposing conical sections 87 and 89.

Now with reference again to FIG. 1, preferably mounted at the top of body 16, is the vacuum pump arrangement 22 previously described, providing vacuum pressure to second hose 24 through the body 12. Power for both suction pump 18 and the vacuum pump arrangement 22 may be from mains supply, with preferably internal control power reticulation at low voltage. Alternatively, the cleaning system may be provided with a rechargeable power source for increased safety and mobility. Switches are provided (not shown) to allow independent switching on and off of pump 18 and vacuum pump arrangement 22, or the component pumps of the vacuum pump arrangement.

The vacuum pump arrangement incorporates a first switch and control for the reservoir of liquid and a supply and recovery sub-system, adapted to selectively switch the sub-system from an operational to a non-operational condition. A further switching mechanism acts to modulate the vacuum pump arrangement from an operational to a non-operational condition. By these means the duty cycles of the vacuum pump arrangement and the sub-system can be selected as required so that maximum combined electric current draw at any one time is limited to domestic electric output capacity, which is typically 10 amps. Modulation of the vacuum provided by the vacuum pump arrangement may also be effected by use of a variable speed vacuum pump.

In a preferred arrangement, one of the vacuum pumps 70 has an electric current draw substantially equal to the pressure pump 18 (or 118). In this arrangement, that one vacuum pump 70 switches from off to on automatically as the pressure pump 18 or 118 switches from on to off such that the operational states of the one vacuum pump and the pressure pump are mutually exclusive. One-way valves 71 prevent an active vacuum pump 70 drawing air from the adjoining inactive pump when the one vacuum pump is so switched. This arrangement allows the cleaner to move seamlessly with electric current draw always below the allowable maximum between an operational state with pump 18 (or 118) and one vacuum pump running and an operational state with only the 2 vacuum pumps running as the trigger controlling the pump 18 (or 118) is released.

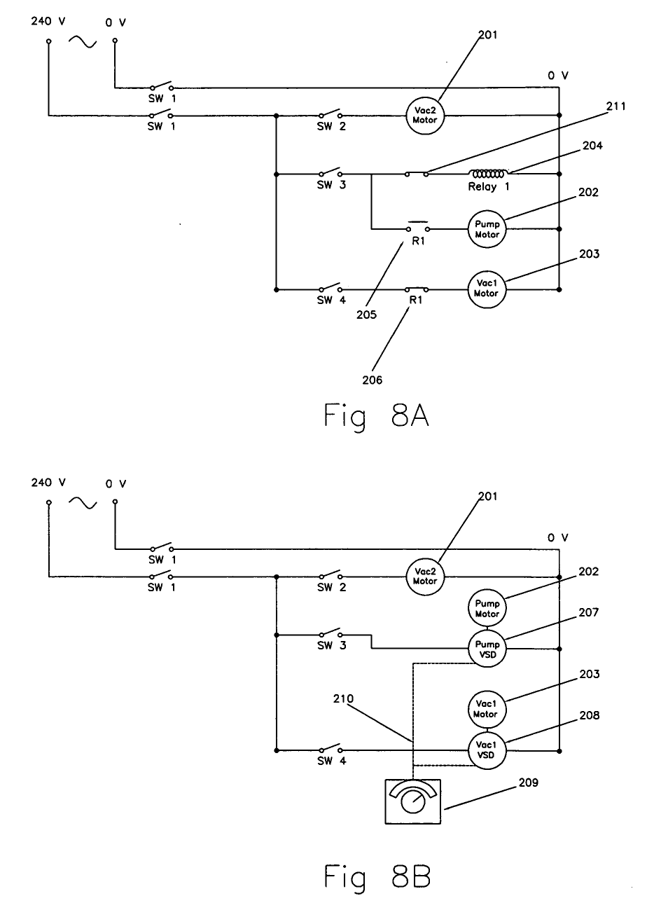

Referring now to FIG. 8A and by way of non limiting example only there is shown a simple circuit diagram that more concisely illustrates how the operation in the immediately foregoing paragraph can be effected. The control circuit of the cleaner is connected to a power supply as shown. In this case the supply is 240 volts AC. The cleaner has two vacuum motors shown in the circuit as Vac1 Motor 203 in this case a 1400 watt motor and Vac2 Motor 201 in this case a 1000 watt motor. The cleaner has a pressure pump motor shown in the circuit as Pump Motor 202 in this case a 1400 watt motor. Isolation switches SW1, SW2, SW3, and SW4 serve to electrically isolate the cleaner as a whole, vacuum motor 2 201, pressure pump motor 202 and vacuum motor 1 203 respectively. The pressure switch 104 of FIG. 6 is abnormally closed switch shown in the circuit diagram as 211. The activation coil of Relay 1 204 is supplied with 240 V through pressure switch 211. Vac1 Motor 203 is powered through the normally closed contacts 206 of Relay 1 204. Pump Motor 202 is supplied through the normally open contacts 205 of Relay 1 204. In operation when power is switched on to the cleaner:

Vac2 Motor 201 will run continuously unless isolated by switch SW2.

Relay 1 204 will immediately activate unless isolated by switch SW3.

Pump Motor 202 will now run as a consequence of Relay 1 204 activating and closing the normally open contacts 205.

Vac1 Motor will not run as a consequence of Relay 1 204 activating and opening the normally closed contacts 205.

This operational state (operational state A) will remain until the outlet pressure of the pump reaches a preset threshold (such as occurs when the trigger of the handpiece is released) and activates the pressure switch 211 whereupon the normally closed contacts will open and Relay 1 204 will deactivate. Deactivation of the Relay 1 204 has the effect of swapping the operational states of Vac1 Motor 203 and Pump Motor 202. This operational state (operational state B) will remain until the pressure is reduced again (such as occurs when the trigger of the handpiece is pulled in) and operational state A is reinstated.

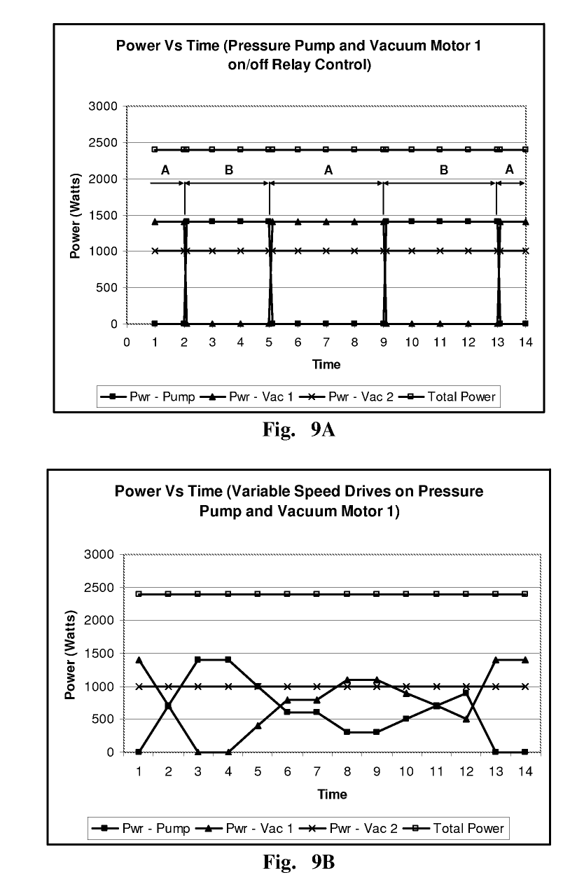

Referring now to FIG. 9A there is shown a time series graph of motor power that illustrates the arrangement described in the foregoing paragraph. The individual power consumed by the three motors Vac1 203, Vac2 201 and Pump 202 and the total combined power of the 3 motors as the cleaner moves between operational states A & B as shown is shown graphically versus time. The power for Vacuum motor 1 (Vac1) and the power for the pressure pump (Pump) cycle sequentially and in a complimentary manner between 0 and 1400 Watts. The total combined power is constant at 2400 Watts.

In another preferred arrangement the complimentary modulation of the at least one vacuum pump 70 and pressure pump 18 (or 118) is achieved by varying the speed of the at least one vacuum pump 70 and/or pressure pump 18 (or 118) by electronic means.

Referring now to FIG. 8B and by way of non limiting example only there is shown a simple circuit diagram that more concisely illustrates how the operation in the immediately foregoing paragraph can be effected. The control circuit of the cleaner is connected to a power supply as shown. In this case the supply is 240 volts AC. The cleaner has two vacuum motors shown in the circuit as Vac1 Motor 203 in this case a 1400 watt motor and Vac2 Motor 201 in this case a 1000 watt motor. Vac2 Motor 201 is powered through a variable speed drive system 208. The cleaner has a pressure pump motor shown in the circuit as Pump Motor 202 in this case a 1400 watt motor. Pump Motor 202 is powered through a variable speed drive system 207. Isolation switches SW1, SW2, SW3, and SW4 serve to electrically isolate the cleaner as a whole, vacuum motor 2 201, pressure pump motor 202 and associated Pump VSD 207 and vacuum motor 1 203 and associated vacuum motor 1 VSD 208 respectively. Pump VSD 207 and Vacuum motor 1 VSD 208 are controlled by variable speed control system 209 such that Pump VSD 207 and Vacuum motor 1 VSD 208 are controlled in a complimentary manner whereby Pump motor 202 speeds up as Vacuum motor 1 slows down and Pump motor 202 slows down as Vacuum motor 1 speeds up. The complimentary control being such that the power consumed by Pump motor 202 and Vacuum 1 motor 203 in total never exceeds but is always close to 1400 Watts.

Referring now to FIG. 9B there is shown a time series graph of motor power that illustrates the arrangement described in the foregoing paragraph. The individual power consumed by the three motors Vac1 203, Vac2 201 and Pump 202 and the total combined power of the 3 motors as the variable speed control system 209 of the cleaner alters the relative speeds of the Pump motor 202 and Vacuum motor 1 203 is shown graphically versus time. The power for Vacuum motor 1 203 and the power for Pump motor 202 vary in a complimentary manner between 0 and 1400 Watts with the total combined power of all 3 motors never exceeding and remaining close to 2400 Watts.

Referring now to FIG. 1 and FIG. 2 a hose system 26 with dual passageways 26A and 26B is connected at a first end to a swivel connection 29 and fitting 28 mounted to a side wall of body 12. Hose system 26 may be in the form of two hose bodies co-extruded, two separate hoses retained in close contact by suitable restraining means or two separate hoses one running wholly within the other. These three alternatives are illustrated in enlargements FIGS. 2A, 2B and 2C.

Fitting 28 is arranged to connect each of first hose 20 and second hose 24 to a respective hose passageway within hose system 26. Thus first conduit 20 may communicate with hose passageway 26B and second conduit 24 communicate with hose passageway 26A. The swivel connection 29 allows the hose system 26 to swivel with respect to the cleaner body 12. Hose system 26 is connected at a second end through another swivel connection 29 (that allows the handpiece 30 to swivel with respect to the hose system 26) to a handpiece 30, comprising as best seen in FIG. 2, a hand-held housing 32 and liquid delivery and recovery head 34.

Various preferred arrangements of the handpiece 30 connecting to hose assembly 26 are possible, each of which may be best suited to a particular cleaner and brush application. There are however certain features that are common:

Hose system passageways 26A and 26B both must connect to the delivery and recovery head 34. One or both may extend through hand held housing 32.

Hose system passageway 26A that carries the liquid under pressure from pump 18 (or 118) to handpiece 30 requires a wall construction designed to accept pressure appropriate for the supply pressure of the pump 18 (or 118). Preferably, this wall construction is best achieved by the use of reinforced pressure hose.

Hose system passageway 26B that carries the air and scavenged liquid from the handpiece 30 is necessarily much larger in cross section than passageway 26A that delivers liquid under pressure from pump 18 (or 118) to the handpiece 30.

Hose system passageway 26B must be routed around or through the handheld housing 32 such that the handgrip is not uncomfortable, the passageway does not drag on the target surface and the operator can move the handpiece freely over the target surface.

As shown in FIG. 2, hand held housing 32 preferably includes a trigger lever 36 for controlled opening and closing of passageway 26A. Alternatively the trigger lever 36 operates a first switch and control that firstly switches the said pressure pump between non-operational and operational states and secondly and optionally controls the modulation of the speed and hence output of the said pressure pump.

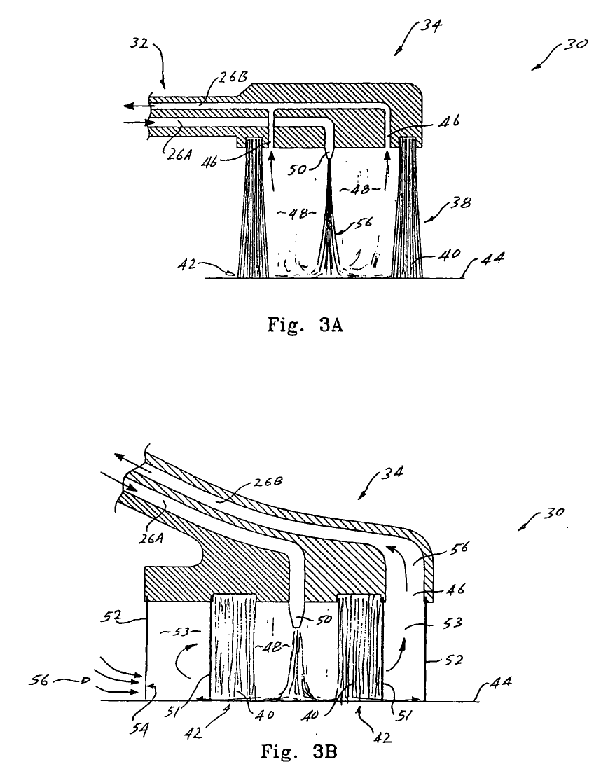

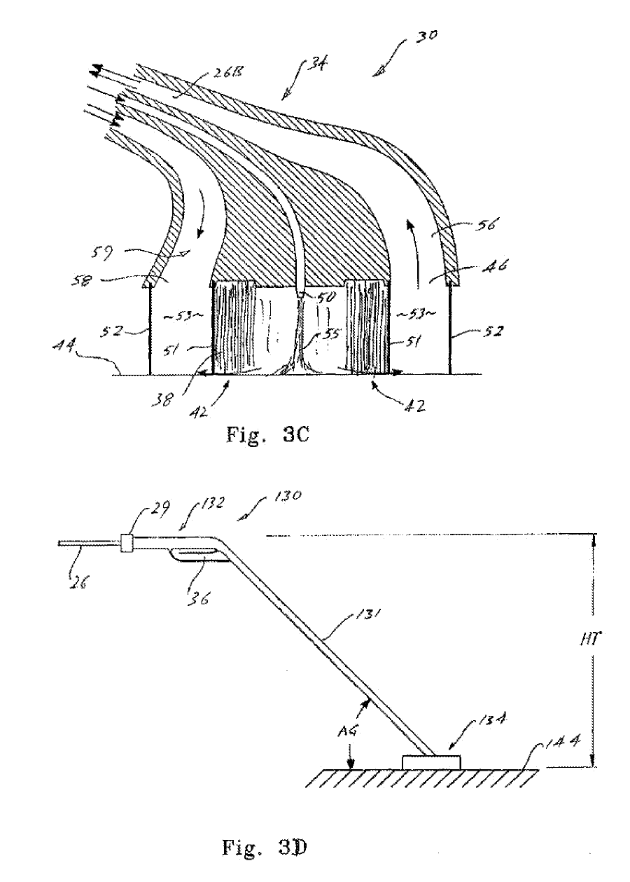

With reference to both FIGS. 2 and 3A, delivery and recovery head 34 includes a brush 38, the bristles 40 of which are arranged to form a relatively thick-walled cylinder. The following description relates to a substantially circular brush assembly, but it will be understood that other shapes such as square, oblong, triangular or elliptical are equally applicable and may suit different cleaning applications.

When the ends 42 of the bristles 40 are in contact with a surface 44 to be cleaned, the brush 38 forms an enclosure 48 in which a lowered air pressure may be maintained by vacuum pump arrangement 22 acting via second hose 24, hose passageway 26B and the at least one vacuum inlet orifices 46 in head 34.

By this means, substantially all of the liquid delivered under pressure from a delivery nozzle 50 in head 34 is sucked back to the vacuum pump arrangement 22 to be released back into body 12 and returned to the liquid volume 16 for reuse. Delivery nozzle 50 may be adapted to provide a fan-shaped, vee-shaped or conically-shaped spray pattern.

With reference to FIG. 3B there is shown a preferred form of brush assembly utilising flexible rubber type skirts. When the ends 42 of the bristles 40 are in contact with a surface 44 to be cleaned, the brush forms an enclosure 48 into which liquid is delivered under pressure from a delivery nozzle 50 in head 34. In this preferred embodiment of a delivery and recovery head 30, the head is provided with an inner skirt 51 and an outer skirt 52 of a flexible, non-marking elastomeric material, such as a silicone rubber. Preferably skirts 51 and 52 are releasably attached to allow for easy replacement in case of wear or damage.

Inner skirt 51 and outer skirt 52 when in use, contact the surface 44 forming a smooth walled annular enclosure 53 around circular brush 40, in which a lowered air pressure may be maintained by vacuum pump arrangement 22 acting via second conduit 24, hose passageway 26B and vacuum inlet orifices 46 in head 34. Outer skirt 51 can be provided with at least one aperture 54 to allow air to be drawn into the annular enclosure 53. The cleaning liquid 55 passes out from the enclosure 48 at the ends of the bristles 42 in contact with the surface 44, under the inner skirt 51 and into the second enclosure 53 to be entrained in the airstream 56 as it is drawn through the aperture 54, through the annular enclosure 53 and into the at least one vacuum inlet orifice 46.

In a preferred arrangement, outer skirt 52 is angled in towards inner skirt 51 such that when pressure is applied to the delivery/recovery head 30 against surface of application 44, outer skirt 52 slidingly folds inwards so as to substantially maintain integrity of the enclosure and the seal with surface 44.

In a further preferred arrangement, outer skirt 52 generally complimenting an outer array of bristles (not shown) is angled out away from inner skirt 51 such that when pressure is applied to the delivery/recovery head 30 against surface of application 44, outer skirt 52 slidingly folds outwards so as to substantially maintain integrity of the enclosure and the seal with surface 44 and to increase the effective cleaning area of the delivery/recovery head 30.

In a further preferred form, the extension of outer skirt 52 from the base portion is greater than the extension of the generally annular array of bristles 40 and the generally annular outer array of bristles (not shown) if present; the extension of the inner skirt 51 being less than the extension of the array of bristles.

With reference to FIG. 3C there is shown another preferred form of brush assembly utilising flexible elastomeric type skirts, but in this embodiment also provided with pressurised air. When the ends 42 of the bristles 40 in this arrangement are in contact with a surface 44 to be cleaned, the brush again forms an enclosure 48 into which liquid 55 is delivered under pressure from a delivery nozzle 50 in head 34. As before, inner skirt 51 and outer skirt 52 contact the surface 44 forming a second annular enclosure 53 in which a lowered air pressure may be maintained by vacuum pump arrangement 22 acting via second conduit 24, hose passageway 26B and the at least one vacuum inlet orifices 46 in head 34. In addition pressurised air 59 is introduced to annular enclosure 53 through at least one air inlet nozzle 58. The cleaning liquid 55 passes out from the enclosure 48 at the ends of the bristles 42 in contact with the surface 44, under the inner skirt 51 and into annular enclosure 53 to be entrained in the airstream 56 as it enters annular enclosure 53 and into the at least one vacuum inlet orifice 46. Preferably said pressurised air 59 is supplied from the vacuum pump exhaust manifold 75 and hose 77 as shown in FIG. 5.

Now with reference to FIG. 3D there is shown another preferred form of the hand piece 130 (particularly suited to the cleaning of walls and floors where some scrubbing action may be necessary) wherein a hand held housing 132 and the trigger assembly 36 are located further away from the brush head 134 but rigidly connected to it in the manner of a broom head and handle by means of a strong rigid connecting piece 131. Preferably the connecting piece 131 also acts as the conduit for at least the high pressure liquid delivery to the delivery/recovery head 134. Preferably the delivery/recovery head 134 takes one of the forms depicted in FIG. 3A, 3B or 3C. Preferably the hand piece 130 is constructed such that the distance HT of the hand held housing 132 from the target surface 44 is in the range 700-1000 mm. More preferably HT=800 mm. Preferably the angle AG subtended by connecting piece 131 and the target surface 44 is in the range 40-55 degrees. More preferably AG=45 degrees.

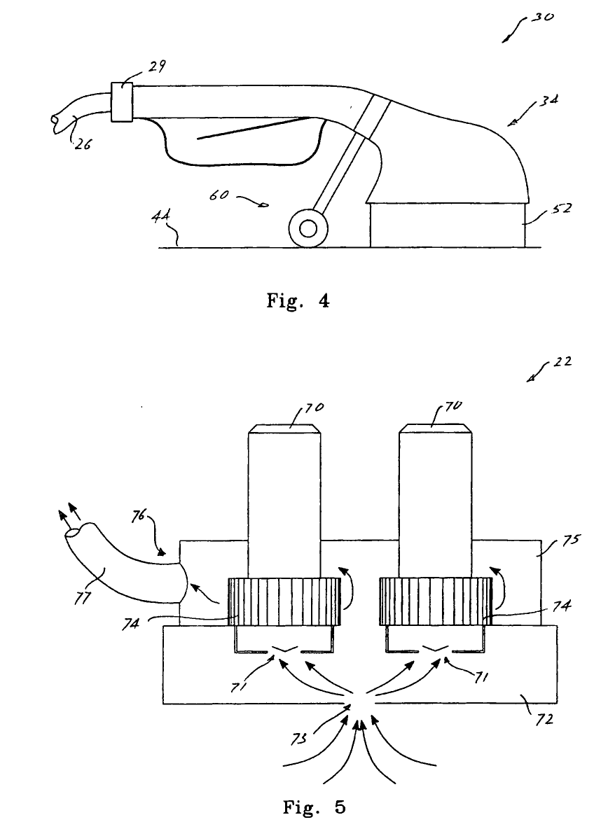

For some applications, to assist in maintaining the bristles of brush 38 and skirts 51 and 52 in contact with surface 44 and thus also ensuring delivery nozzle 50 remains at an optimum distance from surface 44, a detachable trailing wheel device 60 may be provided on handle piece 32 as shown in FIG. 4. The support for the trailing wheel may be made adjustable in length (not shown) so as to alter the height of the delivery nozzle and inlet orifices from the surface.

Referring again now to FIGS. 3A, 3B and 3C there is shown a delivery nozzle 50 within a brush assembly. In a preferred embodiment said delivery nozzle is adjustable such that the spray pattern of liquid issuing from the said delivery nozzle can be made smaller and more concentrated or wider and less concentrated.

Referring again now to FIG. 1, interposed between a liquid outlet 56 of vacuum pump arrangement 22, is a primary filtration system 58 adapted to remove particulate matter from the recovered liquid stream. A further secondary filter system (not shown) may be provided at the inlet of pump 18.

By this means a small volume of water initially introduced into the body 12 of the device, may be re-used many times over during a cleaning operation. When that operation is completed the water may be discharged, either for garden use for example or to normal waste water drainage.

### IN USE

In use, the system herein described allows effective cleaning of vehicles and other surfaces in a domestic environment. By the combination of relatively high pressure and the recovery and recycling of a relatively small initial volume of water, the present system provides a significant contribution to the conservation of water resources.

The above describes only some embodiments of the present invention and modifications, obvious to those skilled in the art, can be made thereto without departing from the scope and spirit of the present invention.

1. A high pressure scavenging cleaning system substantially for domestic use, said cleaner comprising in combination:
(a) a reservoir of liquid and a supply and recovery sub-system located in association with a cleaner body;
(b) a pressure pump as part of the said supply and recovery sub-system;
(c) a variable capacity vacuum pump arrangement as part of the said supply and recovery sub-system coacting with the said pressure pump located within said cleaner body;
(d) a switch and control mechanism controlling the operation of the said pressure pump and the said vacuum pump arrangement in an automatic and coordinated manner;
(e) a flexible connecting hose system comprising a plurality of fluid conducting passages; said hose system extending from said body and connected at a first end to said cleaner and at a second end to a delivery/recovery head; said passages in fluid communication with said reservoir of liquid and said supply and recovery sub-system; at least one of said passages further in vacuum communication with said vacuum pump arrangement,
and wherein the said variable capacity vacuum pump arrangement is modulated in a continuous or stepwise manner or simply switched between a non-zero minimum and a maximum capacity in a complimentary, reverse manner to the said pressure pump as it is modulated in a continuous or stepwise manner or simply switched between a maximum and zero capacity by the said switch and control mechanism such that the combined electric current draw for both said pressure pump and said vacuum pump arrangement is maintained substantially constant and at any one time below but close to a preset maximum and wherein the sum of the individual maximum electric current draws for the said vacuum pump arrangement and the said pressure pump each in isolation is significantly greater than said preset maximum; the arrangement being such that at any one time the said cleaner generates an optimum vacuum capacity, by substantially utilising the allowable electric current; said allowable electric current being the difference between the said preset maximum and the electric current draw of the pressure pump at the said any one time and wherein said delivery/recovery head is separated from the said body of the said cleaner by the said communicating hose system and wherein said delivery/recovery head can be light and easily moved over surfaces to be cleaned, of any orientation from horizontal to vertical (such as a motor vehicle body) and wherein said delivery/recovery head includes a delivery nozzle and at least one liquid recovery inlet orifice, whereby liquid from said reservoir of liquid and said supply and recovery sub-system is delivered at high-pressure to a target surface of application, and wherein substantially all said liquid so delivered is recovered and repeatedly reused by the cleaner.

2. The cleaning system of claim 1 wherein said preset maximum electric current draw is substantially equal to the maximum allowable electric current draw from a domestic power outlet.

3. The cleaning system of claim 1 wherein said switch and control is adapted to selectively enable all individual motorized components of the said supply and recovery sub-system to be manually switched to a non-operational state.

4. The cleaning system of claim 1 wherein said vacuum pump arrangement comprises a plurality of vacuum pumps fitted to a common vacuum receiving chamber; each of said plurality of vacuum pumps individually controllable such that said vacuum pump arrangement as a whole exhibits a modulating effect and is capable of delivering a variable air flow and vacuum with a corresponding variable electrical current draw.

5. The cleaning system of claim 4 wherein said plurality of vacuum pumps comprises two vacuum pumps.

6. The cleaning system of claim 5 wherein one vacuum pump of said two vacuum pumps has a maximum electric current draw substantially equal to the maximum electric current draw of said one pressure pump and wherein said one vacuum pump is arranged to switch from off to on automatically as said pressure pump switches from on to off such that the operational states of said one vacuum pump and said pressure pump are mutually exclusive thereby ensuring that the total electric current draw for the cleaner remains substantially constant and can never include both the electric current draw of the said vacuum pump and the said pressure pump at the same time.

7. The cleaning system of claim 4 wherein each of said vacuum pumps is provided with a one-way valve adapted to prevent an operational vacuum pump drawing air through an adjacent non-operational vacuum pump, thereby to ensure substantially all air entering said common vacuum receiving chamber is drawn from the supply and recovery sub-system so as to maximise scavenging of liquid at the delivery/recovery head.

8. The cleaning system of claim 1 wherein the modulation of said vacuum pump arrangement is effected by means of an at least one vacuum pump provided with an electronic variable speed drive system.

9. The cleaning system of claim 1 wherein the modulation of said pressure pump is effected by means of providing said pressure pump with an electronic variable speed drive system.

10. The cleaning system of claim 1 wherein the modulation of said vacuum pump arrangement and said pressure pump is effected by means of providing at least one vacuum pump and the said pressure pump with an electronic variable speed drive system on each.

11. The cleaning system of claim 10 wherein said electronic variable speed drive systems are in turn controlled by an electronic control in a complimentary manner such that as the pressure pump speeds up the at least one vacuum pump slows down such that the combined electric current draw for both said pressure pump and said vacuum pump arrangement is maintained substantially constant and below the preset maximum.

12. The cleaning system of claim 1 wherein at least one swivel connection is located in said hose system.

13. The cleaning system of claim 1 wherein said liquid from said reservoir of liquid and a supply and recovery sub-system is delivered by the said pressure pump at a pressure up to 3000 psi.

14. The cleaning system of claim 1 wherein said cleaner further incorporates a liquid separation device whereby liquid returning to said cleaner is substantially separated from an air stream within which it is entrained in order to reduce the amount of entrained liquid droplets presenting to said vacuum pump arrangement and wherein said liquid separation device provides a physical separation between said air stream and said reservoir of liquid within said cleaner.

15. The cleaning system of claim 14 wherein said liquid separation device includes a cyclonic separator.

16. The cleaning system of claim 14 wherein said liquid separation device includes a vane type separator; said vane type separator adapted to separate a liquid from an air stream by means of trapping entrained liquid behind vanes at points where said gas stream is forced to change direction by said vanes.

17. The cleaning system of claim 14 wherein said physical separation is provided by means of a shallow upper cone placed one on top of a shallow inverted lower cone such that said upper cone is pointed upwards and provides a first liquid draining surface extending to a periphery of said liquid separation device and said lower cone and wherein said lower cone forms a tundish; said lower cone truncated to form a central orifice such that liquid having drained from said periphery is captured by said lower cone; said lower cone providing a second draining surface extending to said central orifice.

18. The cleaning system of claim 1 wherein said cleaner body is supported on wheels or skids whereby said cleaner can be urged and moved from a first location to a second location without being lifted clear of the surface upon which it rests.

19. The cleaning system of claim 1 wherein said cleaner further incorporates at least one filter within said body; said at least one filter filtering liquid returned from said delivery nozzle and liquid recovery inlet orifice via said hose system prior to said liquid presenting to the said pressure pump for reuse.

20. The cleaning system of claim 19 wherein said at least one filter comprises a cartridge filter.

21. The cleaning system of claim 19 wherein said at least one filter is fabricated from or contains material adapted to have an affinity with selected contaminants returning to said cleaner body in said air stream and recovered liquid.

22. The cleaning system of any one of claims 19 to 21 wherein said at least one filter within said cleaner body is enclosed within an enclosed filter housing such that the entire surface area of said at least one filter is utilised even at very low liquid levels within said cleaner reservoir.

23. The cleaning system of claim 22 wherein said filter housing is comprised of an inverted, open container sealed but for a small gap at the bottom to allow said liquid to pass through from said reservoir to said at least one filter.

24. The cleaning system of claim 1 wherein a 3-way-valve is located in a liquid conduit between said reservoir of liquid and said pressure pump. Said 3-way-valve connecting at a first port to said reservoir, at a second port to said pressure pump and having a third port available for connection to a supply hose such that any two or all three of said ports may be interconnected.

25. The cleaning system of claim 1 wherein said delivery/recovery head comprises a hand-held housing and a head portion rigidly and strongly connected by a connecting piece such that said head portion can be easily moved over the surface to be cleaned; said head portion incorporating a base portion and a brush assembly and said delivery nozzle and said at least one liquid recovery inlet orifice and wherein said connecting piece is of a length and orientation such that said hand piece is at a practical working distance from the face of the delivery/recovery head for the cleaning of solid surfaces.

26. The cleaning system of claim 25 wherein said delivery nozzle is controlled by a trigger assembly on said hand-held housing and wherein said trigger assembly operates:
(a) a direct acting valve to open and close flow to said delivery nozzle or
(b) a first switch and control that in turn operates the said pressure pump.

27. The cleaning system of claim 26 wherein said pressure pump is provided with an over-pressure sensing switch adapted to detect when pressure supplied by said pump exceeds a predefined threshold and wherein said overpressure switch acts to turn off said pump when flow from said pump is obstructed when said trigger is released to operate said direct acting valve to close flow to said delivery nozzle while said delivery/recovery head is in use.

28. The cleaning system of claim 25 wherein said delivery nozzle is adjustable such that the spray pattern of liquid issuing from the said nozzle can be made smaller and more concentrated or wider and less concentrated.

29. The cleaning system of claim 25 wherein said delivery nozzle is recessed within said brush assembly; the bristles of said brush or like structure extending beyond said delivery nozzle so as to contact said vehicle body or other surface at a predetermined distance in advance of said delivery nozzle.

30. The cleaning system of claim 25 wherein said bristles of the said brush assembly are arranged in an at least one array; said delivery nozzle located centrally within said at least one array; said at least one array forming an at least one enclosure when in contact with said surface; said at least one enclosure adapted to substantially capture liquid emitted by said delivery nozzle for return to said body via said at least one liquid recovery inlet orifice in communication with the said vacuum pump arrangement through the said hose system.

31. The cleaning system of claim 30 wherein said at least one liquid recovery inlet orifice is arranged at the periphery of said array.

32. The cleaning system of claim 30 wherein said head portion of the said delivery/recovery head is provided with an at least one flexible skirt of elastomeric non-marking material such as silicone rubber attached to the said base portion or the said brush assembly and complimenting or replacing a portion of the said bristles of the said at least one array; said flexible skirts positioned at any one of or combination of the following positions:
(a) the extreme outer periphery of the said at least one array;
(b) the peripheral edges of the said at least one enclosure within the said at least one array;
the arrangement being such that the said at least one flexible skirt substantially maintains a seal with the surface of application and acts to firstly prevent liquid escaping from the said extreme outer periphery of the said at least one array and secondly to channel and guide the said liquid and the air being drawn into the said at least one liquid recovery inlet orifice by the said vacuum pump arrangement via the said hose system.

33. The cleaning system of claim 32 wherein the said head portion comprises the said base portion to which is attached 2 substantially concentric generally annular arrays of bristles; said generally annular arrays forming 2 internal enclosures when in contact with a surface, being a first central enclosure into which liquid is injected through said delivery nozzle fixed to the said base portion and a second outer generally annular enclosure between the said substantially concentric generally annular arrays; said second generally annular enclosure being in fluid communication with at least one said liquid recovery inlet orifice in the base portion and wherein said flexible skirts are positioned at the outer peripheral edges of both the inner and the outer said generally annular arrays; the arrangement being such that cleaning liquid injected into the cleaning head through the said delivery nozzle hits the surface of application and migrates outwardly through and past the bristles of the said inner generally annular array and under the inner said flexible skirt and into the said generally annular enclosure where said liquid is substantially drawn into at least one said liquid recovery inlet orifice communicating with said generally annular enclosure adapted to facilitate capture of said liquid.

34. The cleaning system of claim 33 wherein said outer flexible skirt and said generally annular array of bristles is angled out away from said inner skirt such that when pressure is applied to said delivery/recovery head against said surface of application being cleaned, said outer skirt slidingly folds outwards so as to substantially maintain integrity of said enclosure and said seal with said surface and to increase the effective cleaning area of the said delivery/recovery head above the projected area of the said base portion of the said delivery/recovery head.

35. The cleaning system of claim 32 wherein said at least one flexible skirt is releasably attached to said base portion or said brush portion so as to be readily replaceable when worn or damaged.

36. The cleaning system of claim 1 wherein the said vacuum pump arrangement discharges into an exhaust manifold; said exhaust manifold providing a source of pressurised air and having an exhaust port adapted to accept connection of a blower hose to said vacuum pump arrangement to facilitate blowing down or drying of surfaces.

37. A method for the minimisation of liquid usage in a domestic water-jet cleaning operation within the limitation of a preset maximum electric current draw; said method including the steps of:
(a) supplying said liquid from a portable reservoir of liquid and a supply and recovery sub-system containing a variable capacity vacuum pump arrangement coacting with a pressure pump via a first hose passage and a delivery nozzle of a delivery/recovery head,
(b) providing said delivery/recovery head with a projecting generally annular brush in combination with flexible elastomeric skirts forming an enclosure when ends of bristles of said brush and said skirts are in contact with a surface,
(c) supplying vacuum pressure via a second hose passage to said enclosure so as to substantially return liquid issuing from said delivery nozzle to said reservoir of liquid and a supply and recovery sub-system via said second hose passage,
(d) controlling the said variable capacity vacuum pump arrangement such that the electric current draw for the cleaner is maintained substantially constant and below a preset maximum at all times regardless of the operational state and output of the said pressure pump.

38. The method of claim 37 wherein said cleaning operation is on a hard surface of any orientation amenable to cleaning with a high pressure liquid jet.
